(19) United States
(12) Patent Application Publication
(10) Pub. No.: US 2026/0122729 A1
(43) Pub. Date: Apr. 30, 2026

(54) HEATER FOR A HUMMINGBIRD FEEDER

(71) Applicant: Angelo P. Zambito, Jr., Seattle, WA (US)

(72) Inventor: Angelo P. Zambito, Jr., Seattle, WA (US)

(21) Appl. No.: 19/302,414

(22) Filed: Aug. 18, 2025

Related U.S. Application Data
(60) Provisional application No. 63/712,810, filed on Oct. 28, 2024.

(51) Int. Cl. H05B 3/06; A01K 7/02; A01K 39/02; H05B 3/04; H05B 3/20

(52) U.S. Cl. CPC H05B 3/06; A01K 7/027; A01K 39/0206; H05B 3/04; H05B 3/20; H05B 2203/016; H05B 2203/026

(57) ABSTRACT

A heater for a hummingbird feeder includes a waterproof heating pad with an adhesive surface for attachment to the bottom of a hummingbird feeder, and a power supply system comprising a weather-resistant transformer and power cable. The power cable may be permanently attached to the heating pad or detachably connected via weather-resistant electrical connectors. The heating pad generates thermal energy to prevent nectar from freezing, allowing hummingbirds to feed in cold weather conditions. The compact, universal design fits any hummingbird feeder model and requires no tools for installation.

### CROSS-REFERENCE TO RELATED APPLICATION

This application claims the benefit of priority of U.S. provisional application No. 63/712,810, filed Oct. 28, 2024, the contents of which are herein incorporated by reference.

### FIELD OF THE INVENTION

The present invention relates to heating systems for bird feeders, and more particularly to compact, weather-resistant heaters for hummingbird feeders that prevent nectar from freezing in cold weather conditions.

### BACKGROUND OF THE INVENTION

Hummingbirds are among the most popular birds to attract to residential gardens and yards. These small birds require frequent feeding due to their high metabolic rate, and many bird enthusiasts provide hummingbird feeders filled with sugar water or nectar to supplement natural food sources. However, in cold weather conditions, the liquid feed in hummingbird feeders can freeze, making it inaccessible to the birds and potentially damaging the feeder itself.

Current bird feeder heaters suffer from several significant drawbacks. First, many existing heaters do not fit a wide variety of bird feeder models due to their restrictive design requirements. These heaters are often bulky, do not fit correctly, and/or require additional mounting hardware that may only be compatible with specific feeder types.

Additionally, current bird feeder heaters lack adequate weather resistance due to their attachment mechanisms and electrical connections. Many existing systems require light bulbs and bulky attachments that clamp onto the feeder, creating multiple points where moisture can enter the electrical components, and conversely where heat can escape and reduce the warming capacity. These systems are very limited in terms of feeder compatibility and often fail in harsh weather conditions.

The power supply arrangements for existing bird feeder heaters also present challenges. Some systems use continuous power cable connections that require permanent electrical installation, while others use detachable connections that may not provide reliable electrical contact in outdoor environments. There is a need for flexible power supply options that can accommodate different installation requirements while maintaining reliable operation.

As can be seen, there is a need for bird feeder heaters that address the above drawbacks by providing a compact, universal, weather-resistant heating solution that is safe, easy to install and compatible with a wide variety of hummingbird feeder designs.

### SUMMARY OF THE INVENTION

In one aspect of the present invention, there is disclosed a heater for a hummingbird feeder comprising of a heating pad configured to generate thermal energy, the heating pad having an adhesive surface configured to attach the heating pad to a surface of a hummingbird feeder, and a power supply system electrically coupled to the heating pad and configured to provide electrical power to the heating pad.

In another aspect of the invention, the power supply system includes a transformer and a power cable connecting the transformer to the heating pad, wherein the power cable may be permanently attached to the heating pad or detachably connected to the heating pad via weather-proof electrical connectors.

In yet another aspect of the invention, the heating pad comprises a waterproof electric polyimide silicon heating element that is IP66 waterproof compliant, and the transformer comprises a standard electrical adapter that is at least IP44 waterproof compliant.

These and other features, aspects and advantages of the present invention will become better understood with reference to the following drawings, description and claims.

### BRIEF DESCRIPTION OF THE DRAWINGS

FIG. 1 is a plan view of a heater for a hummingbird feeder in accordance with an embodiment of the present invention;

FIG. 2 is a perspective view of a heater for a hummingbird feeder in accordance with an embodiment of the present invention;

FIG. 3 is a perspective view of a power cord for use in connection with a heater for a hummingbird feeder in accordance with an embodiment of the present invention; and

FIG. 4 is a perspective view of an alternative power cord for use in connection with a heater for a hummingbird feeder in accordance with an embodiment of the present invention.

### DETAILED DESCRIPTION OF THE INVENTION

The following detailed description is of the best currently contemplated modes of carrying out exemplary embodiments of the invention. The description is not to be taken in a limiting sense but is made merely for the purpose of illustrating the general principles of the invention, since the scope of the invention is best defined by the appended claims.

Broadly, embodiments of the present invention provide a heater that prevents liquid feed in bird feeders, such as hummingbird feeders containing nectar, from freezing inside the feeders during cold weather conditions. The heater is water and weather-resistant, allowing the feeder to be used reliably in outdoor environments. The heater includes an electric heating pad that attaches to a surface, such as the bottom, of the feeder using a strong adhesive. When coupled to a power source, the heating pad heats up and warms liquid within the feeder, such as the nectar tray and its contents, thereby preventing freezing of the liquid.

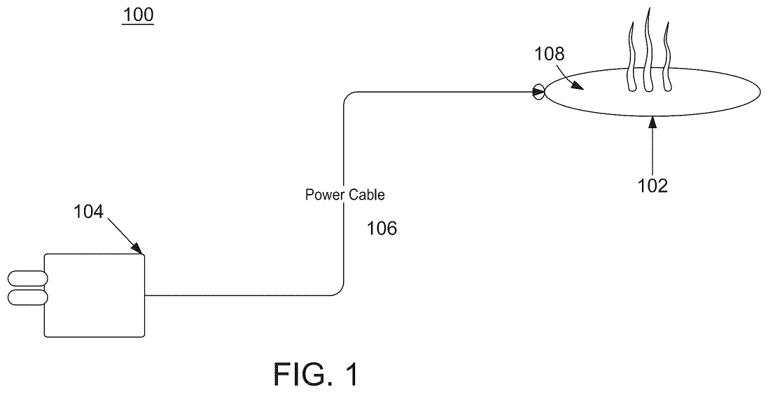

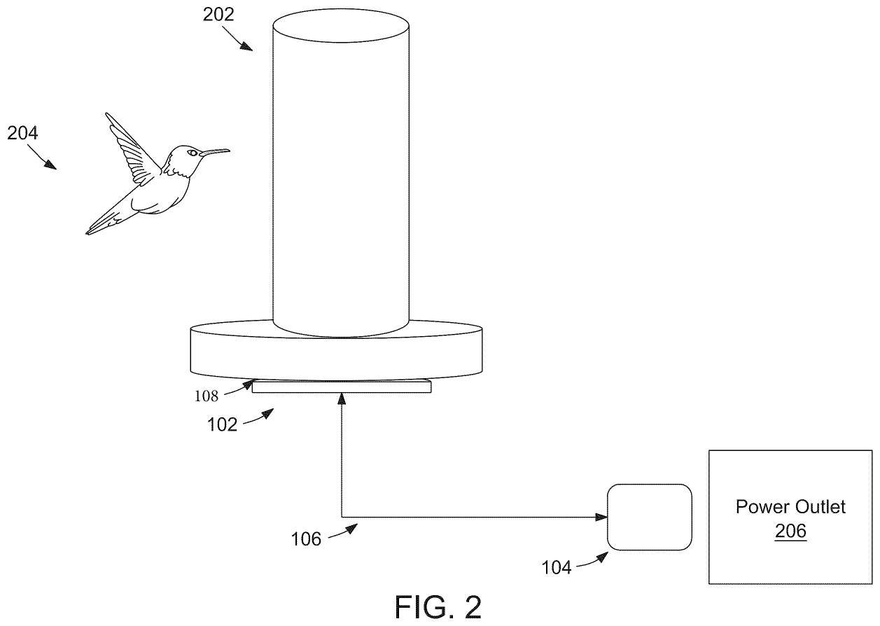

Referring now to FIGS. 1-4, these figures illustrate a bird feeder heater (“heater”) 100 according to aspects of the present invention. While FIGS. 1 and 2 illustrate examples of components of the heater, additional components can be added and existing components can be removed and/or modified without departing from the scope of the invention.

As illustrated in FIGS. 1 and 2, the heater 100 includes a heating pad 102 that provides thermal energy to a bird feeder, such as a hummingbird feeder 202. The heating pad 102 is electrically coupled to a transformer 104 by a power cable 106. The heating pad 102 includes an adhesive surface 108 that allows the heating pad 102 to be coupled directly to a surface of the bird feeder. 202

In one preferred embodiment, the heating pad 102 comprises a waterproof electric polyimide silicon heating pad that is IP66 waterproof compliant. Exemplary specifications for the heating pad 102 include: 12.0 Volts (V), 5.5 Watts (W), and 1.0 Amp (A). However, it should be understood that other specifications may be used depending on the specific application requirements. In addition, while a waterproof electric polyimide silicon heating pad is preferred, other types of heating pads (such as a silicone rubber heater, a PET film heater, a mica heater, a carbon film heater, a printed circuit heater (flexible PCB), a transparent ITO heater, and a foil heater (Aluminum/Copper), to name a few) could also be utilized without departing from the spirit of the invention.

The transformer 104 preferably comprises a standard electrical power adapter that is at least IP44 waterproof compliant. Exemplary specifications for the transformer 104 include: 12.0 V output and 1.0 A capacity. The transformer 104 is configured to convert standard household AC power (typically 110-120V AC in the United States) to the appropriate DC voltage and current required by the heating pad 102.

As illustrated in FIG. 2, the heating pad 102 can be attached to the bottom surface of a bird feeder 202, such as a hummingbird feeder, using the adhesive surface 108. When the transformer 104 is plugged into a standard electrical power outlet 206, the heating pad 102 heats up and warms the liquid food tray (such as a nectar tray) and its contents, thereby preventing the freezing of liquid food such as nectar. As a result, a bird 204, such as a hummingbird, can utilize the bird feeder 202 even in cold and/or freezing weather conditions.

The heating pad 102 is designed to quickly and easily attach to the bottom of a feeder tray using a strong adhesive surface 108. The heater 100 represents a universal product that can adapt to a wide variety of feeder designs due to its compact size and simple attachment mechanism. The heater 100 uses a simple peel-and-stick application process that does not require tools or complex installation procedures. The heater 100 is sufficiently small to fit virtually any model of hanging hummingbird feeder, and all components are designed to be water and weather-resistant for reliable outdoor operation.

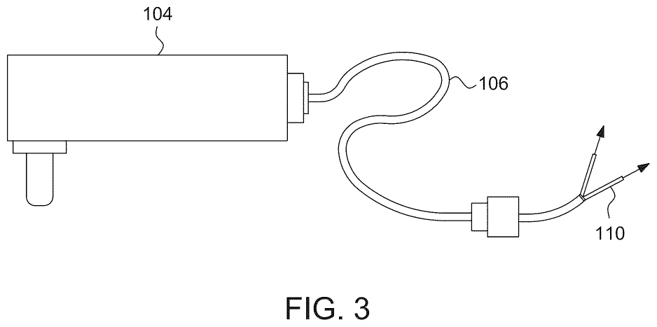

Referring now to FIG. 3, there is shown a first embodiment of a power supply system for the heater 100. In this embodiment, the power cable 106 extends continuously from the transformer 104 to a connection point 110 where it connects to the heating pad. The connection point 110 may comprise a splice connection or a low-profile connector that provides a permanent or semi-permanent water and weather resistant electrical connection. This configuration provides a highly reliable electrical connection that is less susceptible to disconnection due to weather conditions or mechanical stress. The direct connection also minimizes potential points of moisture ingress that might occur with larger detachable connectors.

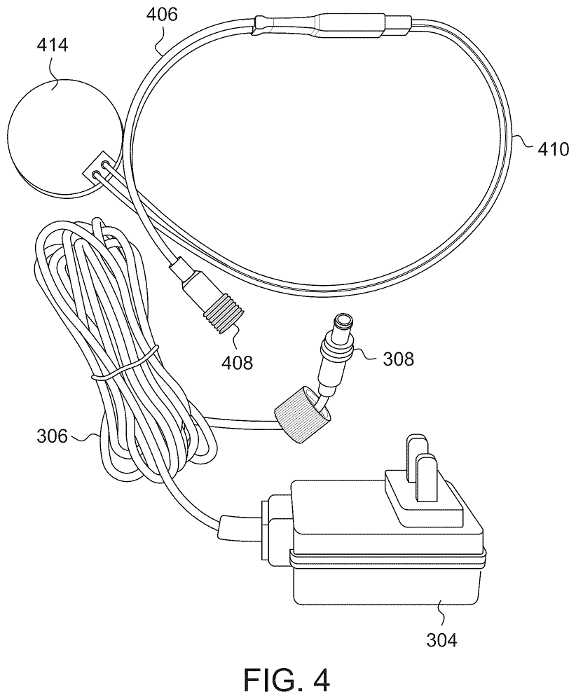

Referring now to FIG. 4, there is shown an alternative embodiment of a power supply system for the heater 100. In this embodiment, the power cable is comprised of multiple segments that are detachably connected via electrical connectors. Specifically, a first power cable segment 306 extends from the transformer 304 and terminates in a first male electrical connector 308. A second power cable segment 410 extends from the heating pad 414 and terminates in a second female electrical connector 408 that is configured to mate with the first electrical connector 308.

The detachable connector configuration shown in FIG. 4 provides several advantages. First, it allows for easy replacement of either power cable segment if it becomes damaged. Second, it facilitates storage and transport of the heater system by allowing the components to be separated. Third, it enables the use of different power cable lengths depending on the specific installation requirements. Fourth, it allows for the possibility of using alternative power sources, such as battery packs or solar panels, by simply connecting a different power cable assembly with the appropriate connector.

Both the continuous cable configuration of FIG. 3 and the detachable connector configuration of FIG. 4 provide reliable power delivery to the heating pad 102 while offering different advantages depending on the specific application and user preferences. The FIG. 3 embodiment emphasizes connection reliability and weather sealing, while the FIG. 4 embodiment emphasizes modularity and serviceability.

In various embodiments, the size, shape, positioning, and/or heat-generating capacity of the heating pad 102 can be modified to suit different feeder sizes and heating requirements. For example, in certain embodiments the heating pad could be incorporated into a strip configuration that could be positioned around the body of the feeder. Similarly, the specifications of the transformer 104 can be adjusted according to the specifications of the chosen heating pad 102. The wire length and gauge for the power cable 106 can be selected for any desired length, provided the electrical specifications meet the power requirements of the heating pad 102.

In some embodiments, the power cable 106 and transformer 104 can be replaced with alternative power sources, such as portable power supplies, battery packs, solar panels, or other suitable power sources. This flexibility allows the heater system to be used in locations where standard electrical outlets are not available.

Installation and use of the heater 100 is straightforward. To use the heater, a user opens the package and removes the heating pad 102 and the power supply components. The user then cleans the bottom surface of the feeder tray to ensure proper adhesion. Next, the user removes a protective backing from the adhesive surface 108 of the heating pad 102 and presses it firmly against the center of the bottom surface of the feeder tray to attach it securely. Finally, the power supply is connected to a standard electrical outlet (or alternative power source) to activate the heater.

The compact design and universal compatibility of the heater 100 make it suitable for use with virtually any hummingbird feeder design. The weather-resistant construction ensures reliable operation in various outdoor conditions, while the simple installation process makes it accessible to users regardless of their technical expertise.

It should be understood, of course, that the foregoing relates to exemplary embodiments of the invention and that modifications may be made without departing from the spirit and scope of the invention as set forth in the following claims.

What is claimed is:

1. A heater for a hummingbird feeder comprising a heating pad configured to generate thermal energy, the heating pad having an adhesive surface configured to attach the heating pad to a surface of a hummingbird feeder; and a power supply system electrically coupled to the heating pad and configured to provide electrical power to the heating pad.

2. The heater of claim 1, wherein the power supply system comprises:
a transformer configured to convert alternating current power to direct current power suitable for the heating pad; and
a power cable assembly electrically connecting the transformer to the heating pad.

3. The heater of claim 2, wherein the power cable assembly comprises a continuous cable extending from the transformer to the heating pad.

4. The heater of claim 2, wherein the power cable assembly comprises:
a first power cable segment extending from the transformer and terminating in a first electrical connector; and
a second power cable segment extending from the heating pad and terminating in a second electrical connector configured to mate with the first electrical connector.

5. The heater of claim 4, wherein the first and second electrical connectors are weather-resistant connectors that maintain reliable electrical contact in outdoor conditions.

6. The heater of claim 4, wherein the power cable assembly is configured to be separated at the electrical connectors.

7. The heater of claim 1, wherein the heating pad comprises a waterproof electric polyimide silicon heating element.

8. The heater of claim 7, wherein the heating pad is IP66 waterproof compliant.

9. The heater of claim 2, wherein the transformer is at least IP44 waterproof compliant.

10. The heater of claim 1, wherein the heating pad has specifications of approximately 12.0 Volts, 5.5 Watts, and 1.0 Amp.

11. The heater of claim 2, wherein the transformer has specifications of approximately 12.0 V output and 1.0 A capacity.

12. The heater of claim 1, wherein the adhesive surface comprises a peel-and-stick adhesive configured to attach the heating pad to a bottom surface of the hummingbird feeder.

13. The heater of claim 1, wherein the heating pad is sized to fit any model of hanging hummingbird feeder.

14. A heater system for a hummingbird feeder comprising:
a waterproof heating pad having an adhesive surface configured to attach to a hummingbird feeder;
a weather-resistant transformer configured to provide power to the heating pad; and
a power connection system electrically coupling the transformer to the heating pad, wherein the power connection system is selectively configurable as either a continuous cable connection or a segmented connection using weather-resistant electrical connectors.

15. The heater system of claim 14, wherein the segmented connection comprises:
a first power cable segment extending from the transformer and terminating in a first connector; and
a second power cable segment extending from the heating pad and terminating in a second connector configured to mate with the first connector.

16. The heater system of claim 14, wherein the heating pad is IP66 waterproof compliant and the transformer is at least IP44 waterproof compliant.
